(19) United States
(12) Patent Application Publication
(10) Pub. No.: US 2007/0091218 A1
(43) Pub. Date: Apr. 26, 2007

(54) Electrostatic discharge protection structure and thin film transistor substrate including the same

(76) Inventors: Chin-Hai Huang, Taipei Hsien (TW); Hong-Tian Yu, Tao-Yuan Hsien (TW); Fu-Yuan Shiau, Chia-I City (TW)

Correspondence Address: NORTH AMERICA INTELLECTUAL PROPERTY CORPORATION, P.O. BOX 506, MERRIFIELD, VA, 22116, US

(21) Appl. No.: 11/163,605

(22) Filed: Oct. 25, 2005

(51) Int. Cl. G02F 1/1333

(52) U.S. Cl. 349/40

(57) ABSTRACT

An electrostatic discharge protection structure contains a short ring surrounding a display region comprising pixel electrodes and thin film transistors, a plurality of switching elements disposed between the display region and the short ring corresponding to the scan lines and data lines, at least one of which is turned on to electrically connect the short ring and the scan lines and the data lines for introducing electrostatic charges to the short ring when a specific amount of electrostatic charges accumulate on the scan lines and the data lines, a conducting wire electrically connecting a storage capacitor line and the short ring, and a floating conductive pattern crossing over and not contacting the conducting wire, thereby assisting the electrostatic charges in distributing in the floating conductive pattern. Thus, an electrostatic discharge protection can be performed efficiently without increasing the substrate size.

### BACKGROUND OF THE INVENTION

1. Field of the Invention

The present invention relates to an electrostatic discharge protection structure, and particularly to an electrostatic discharge protection structure used in a thin film transistor substrate, the thin film transistor substrate comprising the electrostatic discharge protection structure.

2. Description of the Prior Art

In the manufacture of thin film transistor liquid crystal display devices (TFT-LCDs), electrostatic discharge (ESD) protection has been an important issue. There would be a lot of electrostatic charges accumulating on the surface of the substrate of the display during a series of manufacturing processes, such as, dry etching, and a combination of a TFT substrate and a color filter (CF) substrate, and delivery of the substrate, unless there is a proper way to discharge the charges. Otherwise, the electrostatic charge accumulating to a specific amount will be discharged through any place on the substrate, thus impairing a part of the pixel structure, resulting in display defects or even damage of the whole display device. As the display device increases in size, electrostatic charges accumulated on the substrate increase as well. Accordingly, a good ESD protection is desired.

Please refer to FIG. 1. FIG. 1 is a schematic diagram showing a structure of a TFT substrate of a conventional liquid crystal display panel. As shown in FIG. 1, a TFT-LCD panel 10 comprises a substrate 12. A plurality of scan lines S₁, S₂, . . . , and Sₘ and a plurality of data lines D₁, D₂, . . . , and Dₙ are positioned on the substrate 12. The scan lines S₁, S₂, . . . , and Sₘ orthogonally cross over the data lines D₁, D₂, . . . , and Dₙ to define a pixel matrix (not shown) in an active region 14 on the substrate 12. As shown in FIG. 1, a conventional ESD protection is designed to dispose an inner short ring 18 and a plurality of corresponding switching elements 20 in an outer lead bonding region (OLB) 16 surrounding the display region. In the further outer region surrounding the inner short ring, an outer short ring 22 and a plurality of corresponding switching elements are disposed.

The switching elements 20 are disposed between the inner short ring 18 and the scan lines or the data lines. When any place in the active region attains a voltage from manufacturing processes or electric charge accumulation, the switching elements 20 can be turned on to allow the electric charge to dissipate into the inner short ring 18 through the switching elements 20. The switching elements 24 are disposed between the inner short ring 18 and the outer short ring 22. When the electrostatic charges on the inner short ring 18 accumulates to a specific amount, a specific voltage is attained to turn on the switching elements 24 to allow the electric charges to dissipate into the outer short ring 22 through the switching elements 24. Thus, the electrostatic charges are introduced to other wiring or metal layers through a single point by turning on the switching elements until the electrostatic charges are distributed in the whole display panel. The energy of the electrostatic charges is dissipated and the metal layers attain a same voltage, thus the damage to the display panel is avoided and the ESD protection is effective.

The above mentioned ESD protection design using both an inner short ring and an outer short ring can be used in the chip on film (COF) technique, but not in the chip on glass (COG) technique. The space is not available for the outer short ring in COG technique due to the crowded layout in consideration of cost. However, the electrostatic defects arise when the protection design uses only the inner short ring without the outer short ring, and the efficiency for ESD protection decreases drastically.

Please refer to FIG. 2. FIG. 2 is a schematic diagram showing a conventional structure of a TFT substrate formed by a COG technique. On the substrate, the space is not enough for an outer short ring to be disposed in. As shown in FIG. 2, a TFT substrate 30 comprises a substrate 12, a plurality of source driver integrated circuit (IC) chips 32, and a plurality of gate driver IC chips. A plurality of scan lines S₁, S₂, . . . , and Sₘ and a plurality of data lines D₁, D₂, . . . , and Dₙ are positioned on the substrate 12. The scan lines S₁, S₂, . . . , and Sₘ orthogonally cross over the data lines D₁, D₂, . . . , and Dₙ to define a pixel matrix (not shown) in an active region 14 on the substrate 12. The source driver IC chip 32 and the gate driver IC chips 34 are disposed in the OLB region 16 on the substrate 12. The gate driver IC chips 34 output switch/addressing signals to the scan lines S₁, S₂, . . . , and Sₘ. The source driver IC chips 32 output image data signals to the data lines D₁, D₂, . . . , and Dₙ. An inner short ring 18 and a plurality of corresponding switching elements 20 are disposed between the driver IC chips and the scan lines or the data lines on the OLB region to form an ESD protection structure.

The TFT-LCD panel using the TFT substrate as shown in FIG. 2 comprises only an inner short ring and has insufficient ESD protection. Therefore, the electrostatic energy cannot be efficiently reduced, and electrostatic defects occur.

Therefore, a better ESD protection is needed for making a good quality TFT-LCD panel.

### SUMMARY OF THE INVENTION

An objective of the present invention is to provide an ESD protection structure formed on a substrate having limited space, thereby the electrostatic energy is introduced to a certain place for discharge, while the display quality offered by the element devices in the display region is not affected, to attain an ESD protection effect.

To achieve the above objective, the electrostatic discharge protection structure according to the present invention is formed on a thin film transistor substrate including a transparent insulating substrate, a plurality of scan lines, a plurality of data lines, a plurality of storage capacitor lines, a plurality of thin film transistors, and a plurality of pixel electrodes on pixel regions defined by the scan lines and the data lines. The electrostatic discharge protection structure comprises a short ring formed on the transparent insulating substrate for surrounding a display region comprising the pixel electrodes and the thin film transistors; a plurality of switching elements disposed between the display region and the short ring corresponding to the scan lines and the data lines, at least one of which is turned on to electrically connect the short ring and the scan lines and the data lines for introducing electrostatic charges to the short ring when a specific amount of electrostatic charges accumulate on the scan lines and the data lines; a conducting wire electrically connecting one of the storage capacitor lines and the short ring; and a floating conductive pattern crossing over and not contacting the conducting wire, thereby assisting the electrostatic charges in distributing in the floating conductive pattern.

In another aspect, a TFT substrate using the ESD protection structure according to the present invention is further provided.

The ESD protection structure according to the present invention has a floating conductive pattern crossing over a conducting wire on the space-limited substrate, thereby to introduce electrostatic energy to the floating conductive pattern for energy discharge, in addition to a short ring for distributing electrostatic charges accumulating on the display panel. Accordingly, the ESD protection is efficiently performed without increasing the size of the display panel and the display of the panel is not affected.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram showing a conventional TFT substrate structure having both inner and outer short rings as an ESD protection structure.

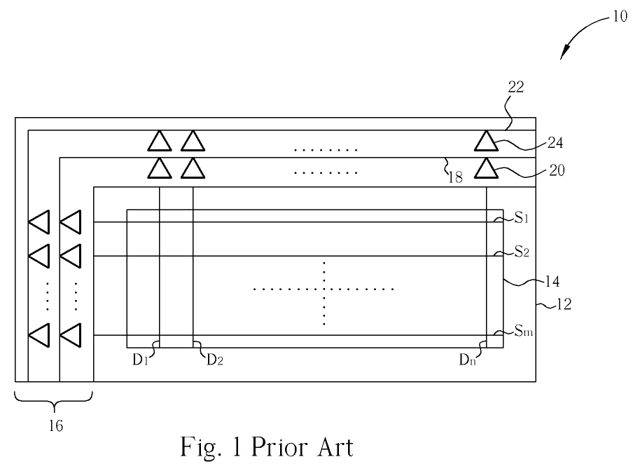

FIG. 2 is a schematic diagram showing another conventional TFT substrate structure having only an inner short ring as an ESD protection structure.

FIG. 3 is a schematic diagram showing the TFT substrate structure according to the present invention, which has the ESD protection structure according to the present invention.

FIG. 4 is a schematic cross-sectional diagram showing a part of the ESD protection structure of one embodiment according to the present invention.

FIG. 5 is a schematic cross-sectional diagram showing a part of the ESD protection structure of another embodiment according to the present invention.

### DETAILED DESCRIPTION

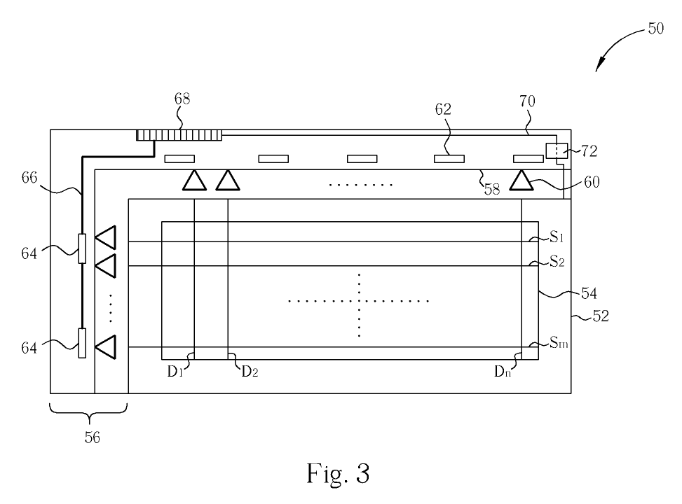

Please refer to FIG. 3. FIG. 3 is a schematic diagram showing a TFT substrate structure having an ESD protection structure according to the present invention. Each drawing herein is a schematic drawing and thus the size of each element is not to scale. As shown in FIG. 3, a TFT substrate 50 comprises a transparent insulating substrate 52, a plurality of source driver IC chips 62, and a plurality of gate driver IC chips 64. A plurality of scan lines S₁, S₂, . . . , and Sₘ and a plurality of data lines D₁, D₂, . . . , and Dₙ are positioned on the transparent insulting substrate 52. The scan lines S₁, S₂, . . . , and Sₘ orthogonally cross over the data lines D₁, D₂, . . . , and Dₙ to define a pixel matrix and pixel electrodes (not shown) are disposed. The source driver IC chip 62 and the gate driver IC chips 64 are disposed in the OLB region 56 on the transparent insulating substrate 52 for outputting image data signals to the data lines D₁, D₂, . . . , and Dₙ and outputting switch/addressing signals to the scan lines S₁, S₂, . . . , and Sₘ, respectively. A gate bus line 66 connects the gate driver IC chips 64 and a flexible printed circuit (FPC) 68. The driver IC chips 62 and 64 are formed using a COG technology. A plurality of storage capacitor lines (not shown) are formed on the transparent insulating substrate 52. The storage capacitor lines and the pixel electrodes are formed with an insulating layer therebetween to form a plurality of storage capacitors.

Generally, the TFT substrate comprises a display region and a non-display region. OLB is positioned in the non-display region.

The TFT substrate 50 comprises a short ring 58 formed on the transparent insulating substrate 52, surrounding a display region 54. The short ring 58 comprises a conductive material, such as, a metal and ITO. A plurality of switching elements 60 are correspondingly disposed at the end of the scan lines and data lines between the scan lines and the short ring 58 and between the data lines and the short ring 58. The switching elements 60 are electrically connected to the short ring 58. The switching elements 60 will be turned on to be electrically connected to the scan lines or the data lines when the electrostatic charges accumulated on the scan lines and the data lines reach a certain amount, to dissipate the electrostatic charges to the short ring. However, the ESD protection is not sufficient using only one short ring 58 since the electrostatic energy is not efficiently reduced. In spite of the insufficiency, the short ring 58 still has a function to dissipate electrostatic charges. The number of the switching elements 60 is not particularly limited, and it may be as much as or less than the number of the scan lines and the data lines.

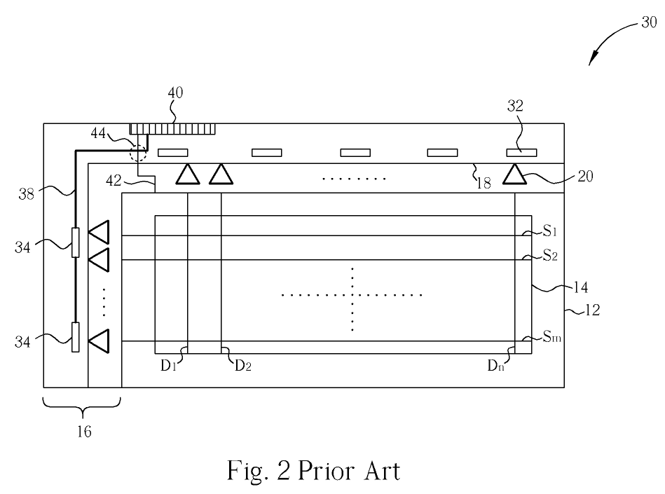

It is noted that the inventors research and discover that, in the conventional TFT substrate 30 as shown in FIG. 2, when a conducting line 42 is extended from a storage capacitor line to a flexible printed circuit (FPC) 40, an electrostatic energy can be introduced to the non-display region through the conducting line 42. At the point 44 where the conducting line 42 crosses over the gate bus line 38, an electrical breakdown often occurs due to the energy discharge damaging the substrate. The gate bus line 38 is used for the gate wiring, having a relative large area among all the wirings. The conducting line 42 and the gate bus line 38 do not contact each other. Electrostatic breakdown at such places accounts for about 90% of electrostatic defects.

In view of the occurrence of the electrical breakdown, a conducting wire 70 is provided on the transparent insulating substrate 52 and electrically connect the storage capacitance lines and the short ring 58, in the present invention. The conducting wire 70 may be a conductive line connecting the storage capacitance lines and FPC 68. A floating conductive pattern 72 is positioned to cross over and does not contact the conducting wire 70. That is, the conductive pattern 72 is on the transparent insulating substrate 52 alone and does not contact other conductive wirings or elements. The conductive pattern 72 and the conducting wire 70 have an insulating layer therebetween. The conductive pattern 72 is provided to have a larger area than an existing conductive line, such that the electric potential is much lower than that of each conductive line, and this facilitates distributing the electrostatic charges in the conductive pattern 72 by breaking down the insulating layer of the conducting wire 70. When electrostatic breakdown occurs at the floating conductive pattern in the non-display region, the ESD protection is accomplished and the display quality for the display panel is not affected.

The location of the cross over of the floating conductive pattern over the conducting wire is not specially limited and can be in a display region or a non-display region of the TFT substrate, and is preferably located in the non-display region. For example, the location may be in any space among the existing wirings in a non-display region adjacent to the display region or on OLB. Therefore, the size of the conductive pattern is not particularly limited, as long as the conductive pattern can be disposed in any space among the existing wirings. Preferably, the conductive pattern is wider than the existing conductive lines. As the conductive pattern becomes wider, the resulting electric potential becomes lower and it better suited to the introduction of electrostatic charges. A width of 200 μm to 500 μm may be selected, for example. The formation of the conductive pattern may be simultaneously performed in the manufacturing process of the TFT substrate, and the process is not affected.

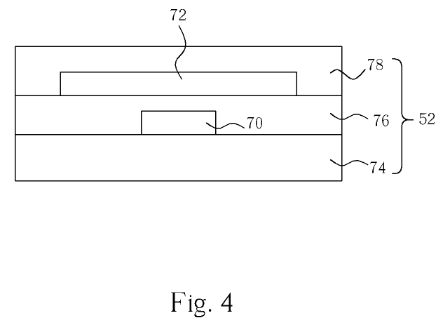

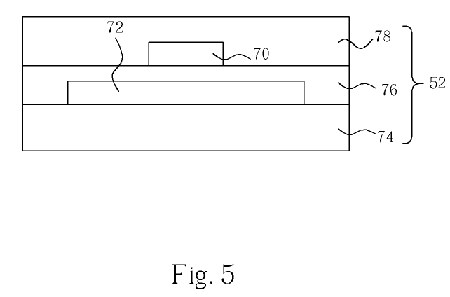

The conducting wire 70 and the conductive pattern 72 may comprise conductive material and be respectively made in a conventional photolithography, etching, or deposition process. It is convenient that the conducting wire 70 is formed to have the same material as that of the scan lines and is formed simultaneously with the scan lines, and the floating conductive pattern 72 is formed to have the same material as that of the data lines and is formed simultaneously with the data lines. For example, as shown in FIG. 4 illustrating a cross sectional view of a transparent insulating substrate 52, a conducting wire 70 is formed on a substrate 74, an insulating layer 76 is formed on the conducting wire 70 and the substrate 74, and a conductive pattern 72 is formed between the insulating layer 76 and a passivation layer 78. Alternatively, the conducting wire 70 may be formed to have the same material as that of the data lines and formed simultaneously with the data lines, and the floating conductive pattern 72 may be formed to have the same material as that of the scan lines and formed simultaneously with the scan lines. For example, as shown in FIG. 5 illustrating a cross sectional view of another transparent insulating substrate 52, a conductive pattern 72 is formed on a substrate 74, an insulating layer 76 is formed on the conducting wire 70 and the substrate 74, and a conducting wire 70 is formed between the insulating layer 76 and a passivation layer 78.

In the present invention, the switching elements 60 may be a structure allowing one-way transmission of electrostatic current, for example, a transistor or an end point discharging structure. The switching elements 60 is turned on to electrically connect the short ring and the scan lines and the data lines for introducing electrostatic charges to the short ring 58 when a specific amount of electrostatic charges accumulate on the scan lines and the data lines. Thus, the breakdown of electrostatic charges in the display region to damage nearby pixels or even the entire display device may be avoided. In such design of the switching element, after the switching element is used for transmitting electrostatic current, it does not need to be patched or removed and will not affect the display quality.

The ESD protection structure according to the present invention is not only limited to being used in a TFT substrate made by COG technology, but also can be used in a TFT substrate made by COF technology. Therefore, an outer short ring may be further provided to the TFT substrate for surrounding the short ring 58 on the transparent insulating substrate. With a plurality of switching elements set between the short ring and the outer short ring, when a specific amount of electrostatic charges on the short ring has accumulated, the switching element will be turned on for electrically connecting the outer short ring and the short ring to introduce electrostatic charges into the outer short ring. Thus, there is further protection in addition to the ESD protection structure comprising the short ring and a floating conductive pattern.

The ESD protection structure according to the present invention is characterized by introducing the electrostatic charges accumulated on the display panel to a specific place and discharging at the specific place for providing the ESD protection function. Compared with the conventional technology, the present invention has the following advantages:

1. The concept for reducing energy “by uniformly distributing the electrostatic charges” in the past is changed to “by energy discharge” in the present invention. The electrostatic energy is introduced to a certain place for discharge, and the display of the panel is not affected.

2. Proper ESD protection is still attained in the situation that an outer short ring is not provided due to an insufficient space in the substrate.

3. The design is simple and easily implemented. Although the circuit design is not complicated, the risk of circuit failure is avoided.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electrostatic discharge protection structure positioned on a thin film transistor substrate including a transparent insulating substrate, a plurality of scan lines, a plurality of data lines, a plurality of storage capacitor lines, a plurality of thin film transistors, and a plurality of pixel electrodes on pixel regions defined by the scan lines and the data lines, comprising:
a short ring formed on the transparent insulating substrate for surrounding a display region comprising the pixel electrodes and the thin film transistors;
a plurality of switching elements disposed between the display region and the short ring corresponding to the scan lines and the data lines, at least one of which is turned on to electrically connect the short ring and the scan lines and the data lines for introducing electrostatic charges to the short ring when a specific amount of electrostatic charges accumulate on the scan lines and the data lines;
a conducting wire electrically connecting one of the storage capacitor lines and the short ring; and
a floating conductive pattern crossing over and not contacting the conducting wire, thereby assisting the electrostatic charges in distributing in the floating conductive pattern.

2. The electrostatic discharge protection structure of claim 1, wherein the transparent insulating substrate comprises the display region and a non-display region, and the floating conductive pattern crosses over the conducting wire in the non-display region.

3. The electrostatic discharge protection structure of claim 1, wherein the transparent insulating substrate comprises the display region and a non-display region, and the floating conductive pattern crosses over the conducting wire in an outer lead bonding region of the non-display region.

4. The electrostatic discharge protection structure of claim 3, wherein a plurality of source driver IC chips and a plurality of gate driver IC chips are positioned in the outer lead bonding region for outputting image data signals to the data lines and outputting switch/addressing signals to the scan lines, respectively.

5. The electrostatic discharge protection structure of claim 1, wherein the transparent insulating substrate comprises the display region and a non-display region, and the conducting wire is electrically connected to one of the storage capacitor lines positioned in the non-display region.

6. The electrostatic discharge protection structure of claim 1, wherein the conducting wire is formed to have the same material as that of the scan lines and is formed simultaneously with the scan lines, and the floating conductive pattern is formed to have the same material as that of the data lines and is formed simultaneously with the data lines.

7. The electrostatic discharge protection structure of claim 1, wherein the conducting wire is formed to have the same material as that of the data lines and is formed simultaneously with the data lines, and the floating conductive pattern is formed to have the same material as that of the scan lines and is formed simultaneously with the scan lines.

8. The electrostatic discharge protection structure of claim 1, further comprising:
an outer short ring formed on the transparent insulating substrate for surrounding the short ring; and
a plurality of switching elements disposed between the short ring and the outer short ring to be turned on for electrically connecting the outer short ring and the short ring to introduce electrostatic charges into the outer short ring when a specific amount of electrostatic charges on the short ring has accumulated.

9. A thin film transistor substrate, comprising:
a transparent insulating substrate;
a plurality of scan lines formed on the transparent insulating substrate,
a plurality of scan lines formed on the transparent insulating substrate and intersecting the scan lines respectively;
a plurality of thin film transistors formed on the transparent insulating substrate, wherein, each thin film transistor comprises a gate, a channel, a source, and a drain, and the gates are electrically connected to the scan lines and the source are electrically connected to the data lines;
a plurality of pixel electrodes formed in a plurality of pixel regions defined by the scan lines and the data lines;
a plurality of storage capacitor lines formed on the transparent insulating substrate such that a plurality of storage capacitors are formed with the storage capacitor lines and the pixel electrodes with an insulating layer therebetween;
a short ring formed on the transparent insulating substrate for surrounding a display region comprising the pixel electrodes and the thin film transistors;
a plurality of switching elements disposed between the display region and the short ring corresponding to the scan lines and data lines, at least one of which is turned on to electrically connect the short ring and the scan lines and the data lines for introducing electrostatic charges to the short ring when a specific amount of electrostatic charges accumulate on the scan lines and the data lines;
a conducting wire electrically connecting one of the storage capacitor lines and the short ring; and
a floating conductive pattern crossing over and not contacting the conducting wire, thereby assisting the electrostatic charges in distributing in the floating conductive pattern.

10. The thin film transistor substrate of claim 9, wherein the transparent insulating substrate comprises the display region and a non-display region, and the non-display region comprises an outer lead bonding region.

11. The thin film transistor substrate of claim 10, wherein the floating conductive pattern crosses over the conducting wire at the outer lead bonding region.

12. The thin film transistor substrate of claim 10, wherein the conducting wire is electrically connected to one of the storage capacitor lines positioned in the non-display region.

13. The thin film transistor substrate of claim 10, further comprises a plurality of source driver IC chips and a plurality of gate driver IC chips on the outer lead bonding region for outputting image data signals to the data lines and outputting switch/addressing signals to the scan lines, respectively.

14. The thin film transistor substrate of claim 9, wherein the conducting wire is formed to have the same material as that of the scan lines and is formed simultaneously with the scan lines, and the floating conductive pattern is formed to have the same material as that of the data lines and is formed simultaneously with the data lines.

15. The thin film transistor substrate of claim 9, wherein the conducting wire is formed to have the same material as that of the data lines and is formed simultaneously with the data lines, and the floating conductive pattern is formed to have the same material as that of the scan lines and is formed simultaneously with the scan lines.

16. The thin film transistor substrate of claim 10, further comprising:
an outer short ring formed on the transparent insulating substrate for surrounding the short ring; and
a plurality of switching elements disposed between the short ring and the outer short ring to be turned on for electrically connecting the outer short ring and the short ring to introduce electrostatic charges into the outer short ring when a specific amount of electrostatic charges on the short ring has accumulated.
